(19) United States
(12) Patent Application Publication
(10) Pub. No.: US 2007/0218878 A1
(43) Pub. Date: Sep. 20, 2007

(54) Method and system for prioritizing audio channels at a mixer level

(76) Inventors: Charbel Khawand, Miami, FL (US); Christopher C. Fries, Lake Villa, IL (US); Martin T. Karanja, Margate, FL (US); Jianping W. Miller, Coral Springs, FL (US); Chin P. Wong, Parkland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/378,128

(22) Filed: Mar. 16, 2006

(51) Int. Cl. H04M 1/00

(52) U.S. Cl. 455/414.1; 455/550.1

(57) ABSTRACT

The invention is an audio mixer (100) for prioritizing audio channels. The mixer can include a plurality of audio channels (110)—in which each channel can be capable of carrying an audio signal—and can include at least one output (114). The number of outputs can be less than the number of channels and the stage (116) immediately following the output is an output stage. Each channel can include an audio shaper (122) that modifies the audio signals of the channels and can include a priority database (126). The channels can be ranked in the priority database based on their priority in relation to one another. Control logic (128) of a highest ranked channel (N) can signal the audio shapers to modify the audio signals on at least some of the lower ranked channels (1, 2) in accordance with a predetermined priority response.

### BACKGROUND OF THE INVENTION

1. Field of the Invention

The present invention concerns devices that broadcast multiple sources of audio and more particularly, devices that prioritize such broadcasts in view of output constraints.

2. Description of the Related Art

In recent years, mobile communications devices, such as cellular telephones and personal digital assistants (PDA), have become extremely popular with the consuming public. In response, manufacturers of these devices have attempted to gain market share by packing them with new features. As an example, several cellular phones include digital music players to play digital music files. Because of space and fiscal constraints, most devices include only one speaker from which to broadcast audio. As such, the audio channel reserved for a ring tone and an audio channel designated for digital music files may terminate in a single output. In such a configuration, it may be necessary to override the audio channel that plays music with the channel that carries a ring tone signal. As a result, the music file may be stopped or paused, and in current systems, this overriding process is performed at the application level. Unfortunately, this step complicates the software in the system and causes undesirable audio effects.

### SUMMARY OF THE INVENTION

The present invention concerns an audio mixer for prioritizing audio channels. The audio mixer can be part of a mobile communications device and can include a plurality of audio channels—in which each audio channel is capable of carrying an audio signal—and at least one output. The number of outputs may be less than the number of audio channels, and a stage immediately following the output may be an output stage including a speaker. Each audio channel can include an audio shaper—in which the audio shapers can modify the audio signals of the audio channels—and can include a priority database. The audio channels may be ranked in the priority database based on their priority in relation to one another. Also, control logic of a highest ranked audio channel can signal the audio shapers to modify the audio signals on at least some of the lower ranked audio channels in accordance with a predetermined priority response.

In one arrangement, each audio channel can further include an energy detector that can detect an audio signal on the audio channel. In addition, when the energy detector detects an audio signal on the highest ranked audio channel, the control logic of the highest ranked audio channel may signal the audio shapers to modify the audio signals on all lower ranked audio channels in accordance with the predetermined priority response.

In another arrangement, when the energy detector detects an audio signal on the highest ranked channel and the energy detector detects an audio signal on a second highest ranked audio channel, control logic of the second highest ranked audio channel may signal the audio shapers to modify the audio signals on at least some of the lower ranked audio channels in accordance with the predetermined priority response. This process may occur so long as the audio signals on the lower ranked audio channels are not affected by the highest ranked audio channel. As an example, the audio shapers can modify the audio signals in accordance with the predetermined priority response through a scaling function or a fading function.

In another embodiment, the control logic of the highest ranked audio channel can signal the audio shapers of the lower ranked audio channels to adjust the audio signals of the lower ranked audio channels to a second state in accordance with a second predetermined priority response. For example, when the energy detector of the highest ranked audio channel no longer detects an audio signal on the highest ranked audio channel, the control logic of the highest ranked audio channel can signal the audio shapers of the lower ranked audio channels to adjust the audio signals of the lower ranked audio channels to the second state in accordance with the second predetermined priority response.

As an example, the second predetermined priority response can be substantially similar to the first priority response. Moreover, the audio shapers can modify the audio signals in accordance with a predetermined priority response through a scaling function or a fading function.

The present invention also concerns an audio mixer for prioritizing audio channels that can include a plurality of audio channels—in which each audio channel is capable of carrying an audio signal—and at least one output. As an example, the number of outputs may be less than the number of audio channels, and a stage immediately following the output can be an output stage that includes a speaker. The audio mixer may also include at least one audio shaper, which can modify the audio signals of the audio channels, and a priority database. The audio channels may be ranked in the priority database based on their priority in relation to one another. Control logic of a highest ranked audio channel may signal the audio shaper to modify the audio signals on at least some of the lower ranked audio channels in accordance with a predetermined priority response.

The present invention also concerns a method of prioritizing audio channels. The method can include the steps of—at a mixer level in which the stage immediately following the mixer level is an output stage including a speaker—receiving audio signals from a plurality of audio channels and determining that one of the received audio signals is on a highest ranking audio channel in relation to the other audio channels. In response to this determination, the audio signals on at least some of the lower ranked audio channels can be modified in accordance with a predetermined priority response. As an example, modifying the audio signals can further include modifying the audio signals on all the lower ranked audio channels in accordance with the predetermined priority response.

The method can also include the steps of determining that one of the received audio signals is also on a second highest ranked audio channel and modifying the audio signals on at least some of the lower ranked audio channels in accordance with the predetermined priority response. This process may occur so long as the audio signals on the lower ranked audio channels are not affected by the modification based on the highest ranked audio channel.

As another example, modifying the audio signals can further include modifying the audio signals in accordance with the predetermined priority response through a scaling function or fading function. Additionally, the method can include the step of adjusting the modified audio signals to a second state in accordance with a second predetermined priority response. In one arrangement, the second predetermined priority response may be substantially similar to the first priority response. Adjusting the modified audio signals can include adjusting the modified audio signals to the second state in accordance with the second predetermined priority response through a scaling function or a fading function.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of an audio mixer in accordance with an embodiment of the inventive arrangements;

FIG. 2 is an example of a mobile communications device in accordance with an embodiment of the inventive arrangements; and

FIG. 3 illustrates a method of prioritizing audio channels in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “audio mixer” can be defined as any combination of hardware and/or software for mixing any suitable combination of audio signals.

The terms “program,” “application,” and the like as used herein, are defined as a sequence of instructions designed for execution on a computer system. A program, computer program, or application may include a subroutine, a function, a procedure, an object method, an object implementation, an executable application, an applet, a servlet, a source code, an object code, a shared library/dynamic load library and/or other sequence of instructions designed for execution on a computer system.

The present invention concerns an audio mixer for prioritizing audio channels. In one arrangement, the mixer can include a plurality of audio channels—in which each audio channel is capable of carrying an audio signal—and at least one output. The number of outputs may be less than the number of audio channels, and a stage immediately following the output can be an output stage that includes a speaker. In another arrangement, each audio channel can include an audio shaper and a priority database. The audio shaper can modify the audio signals of the audio channels, and the audio channels can be ranked in the priority database based on their priority in relation to one another. Control logic of a highest ranked audio channel can signal the audio shapers to modify the audio signals on at least some of the lower ranked audio channels in accordance with a predetermined priority response. As a result, audio signals can be freely interrupted based on a predetermined priority scheme. Additionally, because such interruptions are performed at the mixer level, as opposed to the application layer, any software complications or negative audio effects are substantially eliminated.

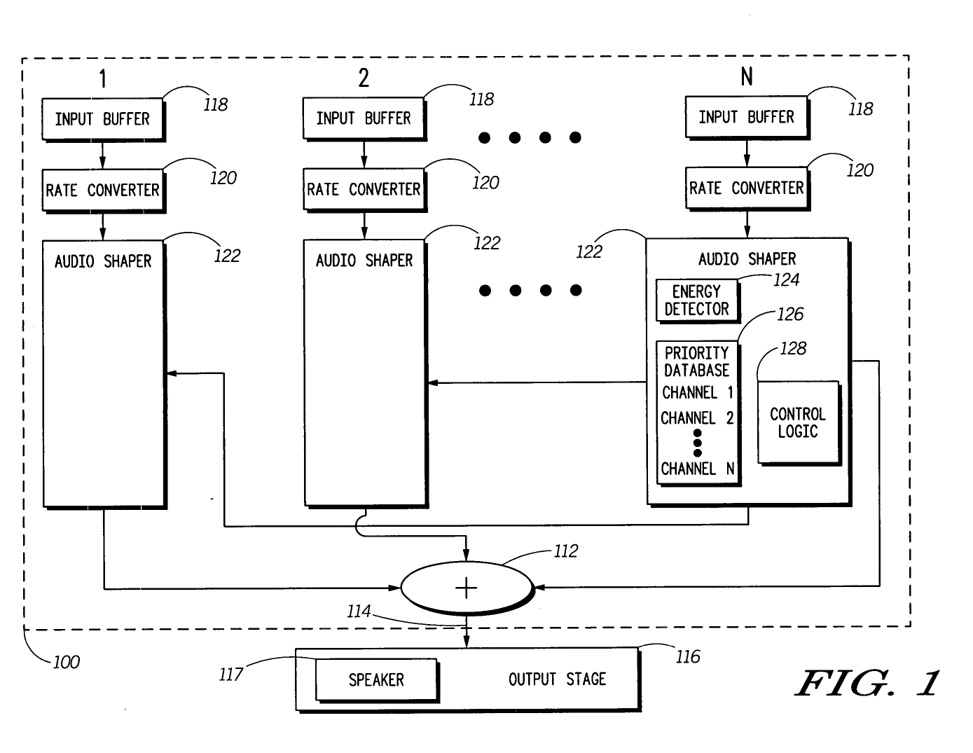

Referring to FIG. 1, an audio mixer 100 for prioritizing audio channels is shown. In one arrangement, the audio mixer 100 can be contained within a mobile communications device 200, and example of which is shown in FIG. 2. It is understood, however, that the audio mixer 100 can be part of any other suitable electronic device. Referring to FIG. 1, the audio mixer 100 can include a plurality of audio channels 110, each of which is capable of carrying an audio signal. The audio mixer 100 can include any suitable number of these channels 110. For purposes of describing the invention, two of the audio channels 110 are designated with the numbers “1” and “2,” while the other is designated with the letter “N,” which represents the highest-numbered audio channel 110.

The mixer 100 can include an adder 112, where the outputs of the audio channels 110 can be summed together. The adder 112 can have an output 114, which may be fed into an output stage 116 having one or more speakers 117. As such, the output stage 116 may immediately follow the output 114 of the audio mixer 100, although other suitable configurations are within contemplation of the inventive arrangements. Although only one output 114 of the audio mixer 100 is shown here, it is understood that the audio mixer 100 can include any suitable number of outputs 114. In one particular arrangement, the number of outputs 114 can be less than the number of audio channels 110.

In one particular embodiment, each of the audio channels 110 can include an input buffer 118, a rate converter 120 that can convert the sampling rates of the audio signals to a uniform value, and an audio shaper 122. In addition, as shown in the audio channel 110 designated with the letter “N,” the audio shaper 122 can include an energy detector 124, which can detect an audio signal on the relevant audio channel 110, a priority database 126 and control logic 128, which can be any suitable combination of software and hardware. In one arrangement, the audio channels 110 can be ranked in the priority database 126 based on their priority in relation to one another. In one arrangement, the audio channels 110 can be ranked in any suitable order. For example, an audio channel 110 can have lower ranked audio channels 110 in its priority database placed in any desired order, and these settings may be changed at any suitable time, including during actual operation of the audio mixer 100. It must be noted that the components listed above can be part of the audio shapers 122 of the other channels 110.

As will be explained below, the control logic 128 of a highest ranked audio channel 110 can signal the audio shapers 122 of at least some of the lower ranked audio channels 110. In response, the audio shapers 122 can modify the audio signals on the lower ranked audio channels 110 in accordance with a predetermined priority response. If so desired, the audio signals on the lower ranked audio channels 110 can be permitted to return to their pre-modified state or some other suitable state. The term audio shaper can be defined as any component or combination of components, either hardware or software, that can modify an audio signal in any suitable fashion.

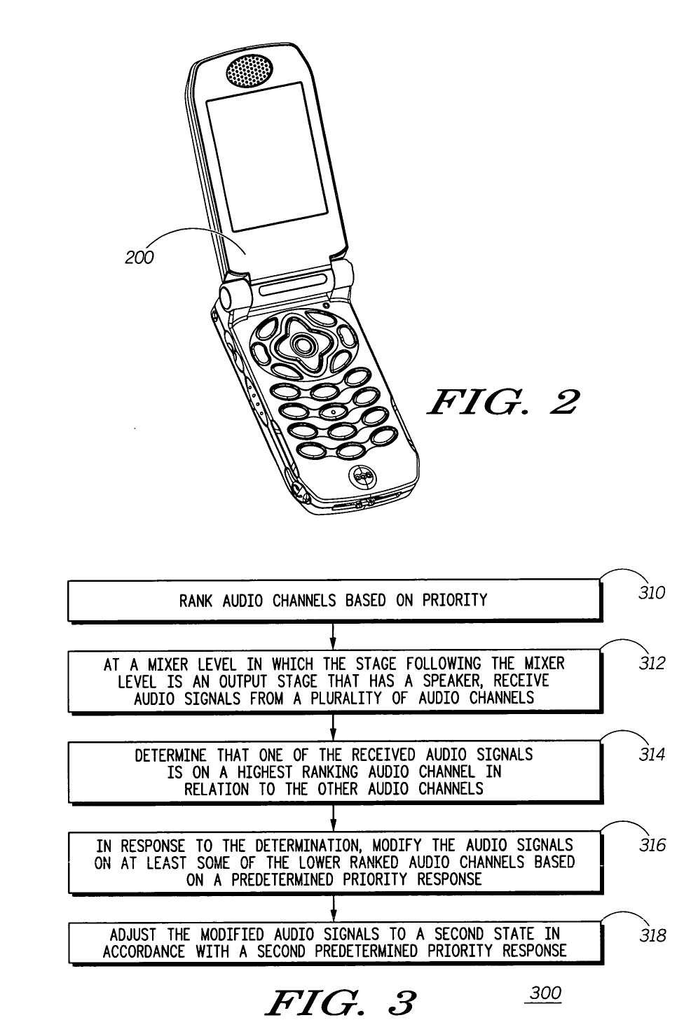

Referring to FIG. 3, a method 300 for prioritizing audio channels is shown. When describing the method 300, reference will be primarily made to FIG. 1, although it is understood that the method 300 can be practiced in any other suitable system or device. Moreover, the steps of the method 300 are not limited to the particular order in which they are presented in FIG. 3. The inventive method can also have a greater number of steps or a fewer number of steps than those shown in FIG. 3.

At step 310, a number of audio channels can be ranked based on priority. For example, referring to FIG. 1, the audio channels 110 can be ranked based on a priority, and this ranking can be stored in the priority database 126. In particular, an electronic device, such as the mobile communication device 200 of FIG. 2, may be capable of generating several audio streams. These signals may be broadcast from the speaker 117 of FIG. 1. As such, given the limited number of outputs, it may be necessary to determine which of the audio channels 110 will be granted priority if two or more of them are carrying audio signals simultaneously. For example, a manufacturer may determine that a ring alert, which notifies the user of an incoming call or text message, may take priority over a signal carrying a digital music file. Thus, the audio channel 110 carrying the ring alert may be given a higher priority than the audio channel 110 carrying the music signal. This priority can be determined by any suitable entity, including the user of the device 200.

In this example, it will be assumed that the audio channel 110 designated with the letter “N,” which may also be referred to as channel N, will have a higher priority over the other audio channels 110. These lower ranked audio channels 110 may also be referred to as channel 1 and channel 2. Continuing with this example, it will be assumed that channel 2 will have a higher priority than channel 1. It must be understood that the invention is in no way limited to this particular configuration, as there are a great number of priority configurations that may apply to the invention.

Referring back to FIG. 3, at step 312, at a mixer level in which the stage following the mixer level is an output stage that has a speaker, audio signals can be received from a plurality of audio channels. Further, at step 314, it can be determined that one of the received audio signals is on a highest ranking audio channel in relation to the other audio channels. In response to this determination, the audio signals on at least some of the lower ranked audio channels can be modified based on a predetermined priority response, as shown at step 316.

For example, referring once again to FIG. 1, in the audio mixer 100, which, as previously noted, can be followed by the output stage 116, audio signals can be received on channel 1. Eventually, the energy detector 124 on channel N may detect an audio signal on channel N. In response, because channel N is a higher ranked channel in the priority database 126, the control logic 128 of channel N can signal the audio shaper 122 of channel 1 to modify the audio signal on channel 1. The control logic 128 can immediately signal the audio shaper 122 or through a programmable time-delay. The modification of the audio signal on channel 1 can be based on a predetermined priority response. As an example, the signaled audio shaper 122 of channel 1 can modify the audio signal on channel 1 through a scaling function or a fading function.

In particular, the scaling function can produce an almost instantaneous drop in the amplitude of the audio signal on channel 1. In contrast, the fading function can cause a more subtle decrease in the amplitude of the audio signal, as the signal can be modified in accordance with a series of incremental drops in energy. Of course, there are many different ways to modify the audio signals on the lower ranked audio channels 110, and the invention is in no way limited to these particular examples. Also, it is important to note that the audio signals that are modified are not necessarily limited to decreases in their energy level, as they may actually be increased, if so desired. The various ways to modify the signals can be determined by a manufacturer or a user of the mobile communications device 200 (see FIG. 2).

Consider another example in which channels 1 and 2 are both carrying audio signals and an audio signal is detected on channel N. In this scenario, the control logic 128 of channel N can signal the audio shapers 122 of the channels 1 and 2 to modify the audio signals on both of them, as channel N is designated as the higher priority channel. In another arrangement, the control logic 128 can be set to only signal one of the lower ranked channels 1 or 2 to permit the audio signal on the other channel that was not signaled to remain unaffected. This setting can be determined by any suitable entity, such as the user, and can be easily changed to accommodate the entity's tastes.

Consider another example in which channel N is the highest priority channel, channel 2 is the next highest priority channel and channel 1 is the lowest priority channel. In this example, channel 1 and channel N are both carrying audio signals, and the energy detector 124 of channel 2 determines that channel 2 has begun to carry an audio signal. By checking the priority database 126 in the audio shaper 122 of channel 2, it can be determined that channel 2 may not interfere with the signal being carried on channel N.

There is a possibility, however, that the control logic 128 of channel 2 may signal the audio shaper 122 of channel 1 to modify the signal on that channel, so long as this signal has not been modified under instruction from the control logic 128 of channel N. This process can apply to any audio channel 110 that is lower in priority than the second highest ranked audio channel 110. Of course, the modification set by the second highest ranked audio channel 110 can be overridden by the highest ranked audio channel 110 at any time, if so desired. The term “second highest ranking audio channel” can refer to any audio channel that is ranked lower in priority than the highest ranked audio channel.

Referring back to FIG. 3, at step 318, the modified audio signals can be adjusted to a second state in accordance with a predetermined priority response. For example, referring once again to FIG. 1, considering the example where channel N has caused a modification of the audio signal on channel 1, the energy detector 124 of channel N may determine that the audio signal is no longer present on channel N. In response, the control logic 128 of channel N can signal the audio shaper 122 of channel 1 to adjust the audio signal on that channel to return to a second state. The adjustment of this signal to the second state can be in accordance with a second predetermined priority response.

As an example, the second predetermined priority response can be substantially similar to the original priority response. As a result, the audio signal on the lower ranked audio channels 110 can be returned to their original levels. For example, if the audio signal on channel 1 was dropped to a first level based on a fading function, then that signal may be returned to its original level through a second fading function similar to the first one. This process can apply to any number of the lower ranked audio channels 110.

It is understood, however, that the invention is not so limited. Specifically, the audio signals may be adjusted to a second state that is different than their original or pre-modified state, such as a higher or even lower energy level. Also, the second predetermined priority response may be different from the original priority response. For example, an audio signal originally modified through a fading function may be adjusted to the second state through a scaling function. In fact, the audio signal on the lower ranked audio channels 110 can be adjusted in any suitable fashion once the audio signal on the higher ranked audio channel 110 is no longer present.

The above examples have been described with each of the audio channels 110 including an audio shaper 122, an energy detector 124, a priority database 126 and control logic 128. It is understood, however, that these components may also be contained within a single unit in which of the audio channels 110 feed into this single unit. Moreover, one or more of the audio channels 110 may be exempt from this prioritization scheme, and any audio signal that such channels 110 may carry will not be affected by the predetermined priority responses.

In view of the inventive arrangements, audio channels may be ranked based on priority and any audio signals that they may carry may be modified in accordance with predetermined priority responses. This process may be executed at a mixer, as opposed to the application layer, which enables easy modifications of the audio signals without software complications or adverse sound effects.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An audio mixer for prioritizing audio channels, comprising:
a plurality of audio channels, each audio channel capable of carrying an audio signal; and
at least one output, wherein the number of outputs is less than the number of audio channels and a stage immediately following the output is an output stage including a speaker;
wherein each audio channel includes an audio shaper, wherein the audio shapers modify the audio signals of the audio channels and includes a priority database, wherein the audio channels are ranked in the priority database based on their priority in relation to one another and wherein control logic of a highest ranked audio channel signals the audio shapers to modify the audio signals on at least some of the lower ranked audio channels in accordance with a predetermined priority response.

2. The mixer according to claim 1, wherein each audio channel further includes an energy detector that detects an audio signal on the audio channel.

3. The mixer according to claim 2, wherein when the energy detector detects an audio signal on the highest ranked audio channel, the control logic of the highest ranked audio channel signals the audio shapers to modify the audio signals on all lower ranked audio channels in accordance with the predetermined priority response.

4. The mixer according to claim 2, wherein when the energy detector detects an audio signal on the highest ranked channel and the energy detector detects an audio signal on a second highest ranked audio channel, control logic of the second highest ranked audio channel signals the audio shapers to modify the audio signals on at least some of the lower ranked audio channels in accordance with the predetermined priority response, so long as the audio signals on the lower ranked audio channels are not affected by the highest ranked audio channel.

5. The mixer according to claim 1, wherein the audio shapers modify the audio signals in accordance with the predetermined priority response through a scaling function or a fading function.

6. The mixer according to claim 1, wherein the control logic of the highest ranked audio channel signals the audio shapers of the lower ranked audio channels to adjust the audio signals of the lower ranked audio channels to a second state in accordance with a second predetermined priority response.

7. The mixer according to claim 6, wherein each audio channel further includes an energy detector that detects an audio signal on the audio channel and when the energy detector of the highest ranked audio channel no longer detects an audio signal on the highest ranked audio channel, the control logic of the highest ranked audio channel signals the audio shapers of the lower ranked audio channels to adjust the audio signals of the lower ranked audio channels to the second state in accordance with the second predetermined priority response.

8. The mixer according to claim 6, wherein the second predetermined priority response is substantially similar to the first priority response.

9. The mixer according to claim 6, wherein the audio shapers modify the audio signals in accordance with a predetermined priority response through a scaling function or a fading function.

10. The mixer according to claim 1, wherein the mixer is part of a mobile communications device.

11. An audio mixer for prioritizing audio channels, comprising:
a plurality of audio channels, each audio channel capable of carrying an audio signal;
at least one output, wherein the number of outputs is less than the number of audio channels and a stage immediately following the output is an output stage including a speaker;
at least one audio shaper, wherein the audio shaper modifies the audio signals of the audio channels; and
a priority database, wherein the audio channels are ranked in the priority database based on their priority in relation to one another and wherein control logic of a highest ranked audio channel signals the audio shaper to modify the audio signals on at least some of the lower ranked audio channels in accordance with a predetermined priority response.

12. The mixer according to claim 11, wherein each audio channel further includes an energy detector that detects an audio signal on the audio channel.

13. The mixer according to claim 12, wherein when the energy detector detects an audio signal on the highest ranked audio channel, the control logic of the highest ranked audio channel signals the audio shaper to modify the audio signals on all lower ranked audio channels in accordance with the predetermined priority response.

14. A method of prioritizing audio channels, comprising:
at a mixer level in which the stage immediately following the mixer level is an output stage including a speaker, receiving audio signals from a plurality of audio channels;
determining that one of the received audio signals is on a highest ranking audio channel in relation to the other audio channels; and
in response to this determination, modifying the audio signals on at least some of the lower ranked audio channels in accordance with a predetermined priority response.

15. The method according to claim 14, wherein modifying the audio signals further comprises modifying the audio signals on all the lower ranked audio channels in accordance with the predetermined priority response.

16. The method according to claim 15, further comprising:
determining that one of the received audio signals is also on a second highest ranked audio channel; and
modifying the audio signals on at least some of the lower ranked audio channels in accordance with the predetermined priority response so long as the audio signals on the lower ranked audio channels are not affected by the modification based on the highest ranked audio channel.

17. The method according to claim 14, wherein modifying the audio signals further comprises modifying the audio signals in accordance with the predetermined priority response through a scaling function or fading function.

18. The method according to claim 14, further comprising adjusting the modified audio signals to a second state in accordance with a second predetermined priority response.

19. The method according to claim 18, wherein the second predetermined priority response is substantially similar to the first priority response.

20. The method according to claim 18, wherein adjusting the modified audio signals comprises adjusting the modified audio signals to the second state in accordance with the second predetermined priority response through a scaling function or a fading function.
